(19) United States
(12) Patent Application Publication
(10) Pub. No.: US 2002/0130896 A1
(43) Pub. Date: Sep. 19, 2002

(54) Image presentation and control

(76) Inventors: Robert Spence, Surrey (GB); Oscar De Bruijn, London (GB)

Correspondence Address: NIXON & VANDERHYE P.C., 8th Floor, 1100 North Glebe Road, Arlington, VA, 22201, US

(21) Appl. No.: 10/094,959

(22) Filed: Mar. 12, 2002

(30) Foreign Application Priority Data
Mar. 16, 2001 (GB) 0106630.7

(51) Int. Cl. G09G 5/00

(52) U.S. Cl. 345/716

(57) ABSTRACT

An apparatus for and method of presenting images contained in a virtu container, the system comprising: a display for displaying at least one virtual container; a processor for driving the display to display images contained in the at least one virtual container displayed on the display; and a user interface for controlling the processor to drive the display; wherein the images are displayed sequentially in a display cycle.

### BACKGROUND OF THE INVENTION

1. Field of the Invention

The present invention relates to a system for and method of presenting images on a display and controlling the presentation of the images.

2. Description of the Prior Art

A particular problem associated with displaying information on displays, particularly small displays, such as in mobile telephones, is the limited size of the area available for the presentation of that information.

It is thus an aim of the present invention to provide an improved system for and method of presenting images on a display and controlling the presentation of the images.

In presenting images on a display it is important to consider how the images are perceived by the user. This is particularly important when a multiplicity of images have to be displayed and the viewer has to attempt to extract salient information from what is presented in order to make a selection. A human perceptual task known as Rapid Serial Visual Processing (RSVP) requires the detection of a target item among a stream of visual stimuli, such as an image sequence presented in the same location in rapid temporal succession. The target item is typically a particular image that the viewer has been primed to detect. It has been proposed that in performing an RSVP task, the attention apparatus of the brain of the viewer grabs the target image when it appears in the image sequence, and then an “attention filter” blocks subsequent images in the temporal sequence from reaching recognition centres of the brain. It is thought that the brain sets up this block to prevent interference with the cognition of the initial target item so that subsequent images are only processed to a level, which allows for their rejection.

This has been rationalised by considering that without the filter working like a gate, closing after the initial stimuli, the attention apparatus would become blocked with irrelevant data. Therefore once the initial data are being processed, the attention apparatus effectively goes off-line, preventing additional data from reaching consciousness.

More recent research has suggested that the attention filter of the brain is not an all-or-nothing gate. Rather, the filter allows semantic information of post-target images to be processed to a deeper level, and through to consciousness, although the filter still acts as a block to visual processing.

It is known to provide image presentation systems with rotating menus where the menu options are selectable. Whilst these known menu systems are useful in addressing the problem of presenting menu options to the user in an intelligible way, they have the disadvantages that to display a large number of menu options simultaneously requires a large display size and even if only a subset of the available menu options are displayed at any one time, it is time consuming for the user to proceed step-by-step through the menu options by rotating the menu manually. Furthermore in known menu systems configured to rotate automatically, typically either the number of menu options displayed is limited or the rotation rate is slow enough to allow the user to visually perceive all of the displayed images. As a consequence, cycling through all of the available menu options is very time consuming and inefficient. Furthermore the automatic menu rotation or display cycle rate is fixed in operation for known systems. Examples of known image presentation systems are briefly described below.

Patent application number WO-A-98/28912 describes a user interface in which a rotating menu is provided. The menu has a perspective that allows for a highlighted option to appear to be in front of the other options. Some of the options rotate off the screen which allows for any number of options to be added to the menu without affecting the shape of the display. The menu options are rotated manually by a user via buttons on a remote control. The remote control also has a button for selecting a highlighted menu option.

The software package Microsoft Powerpoint has a slideshow feature, according to which, a sequence of images is presented in an automated displayed cycle. The user can individually configure the time for which each image is displayed in the slideshow. The timings are configurable prior to running the slideshow.

Patent application number WO-A-01/29644 describes a system in which a three-dimensional display of menu options is presented to a user. According to this system all of the available menu options are simultaneously presented to the user and are continuously selectable. The menu options are configured to rotate. The user is provided with an on/off option which can stop or pause the motion of the menu options.

### SUMMARY OF THE INVENTION

Viewed from one aspect the invention provides an apparatus for presenting images contained in a virtual container, comprising:

(i) a display for displaying at least one virtual container;

(ii) a processor for driving the display to display images contained in said at least one virtual container which is displayed on said display; and

(iii) a user interface for controlling said processor to drive said display;

wherein said images are displayed sequentially in a display cycle at a predetermined rate, said rate being adjustable in operation and wherein said user interface has a selector operable to select at least one target image from said display cycle.

The invention recognises that displaying multiple images on a small display is problematic. With the advent of small portable electronic devices such as personal digital assistants and mobile phones and taking account of the increasing sophistication of software installed on these devices with a multiplicity of available functions and menu options, this problem has become more pronounced. The invention also recognises that the displayed images should be presented to the user in a way that allows important information presented on the display to be readily filtered-out by the user and to cycle through a large number of images in a short space of time.

The invention exploits the RSVP characteristic of the brain's visual processing by displaying images in a sequence at a predetermined rate that is adjustable in operation. Accordingly, images may be displayed in rapid temporal succession, thus allowing for efficient cycling through a large number of options. The image cycle rate must be slow enough to allow for recognition and visual processing of a target image to enable it to be selected, but need not be so slow as to allow for every image in the sequence to be recognised and visually processed during the image cycle.

Furthermore the cycle rate of the images can be adjusted in dependence upon the image type. For example, visual processing of a simple and distinctive line-drawn image will typically take less time than visual processing of an information-dense photographic image. The cycle rate may be determined automatically via an algorithm run by the processor or alternatively the user could be prompted to provide objective input on the image type to be displayed and the cycle rate could be set accordingly by the algorithm. The cycle rate is also adjustable between one or more rates via the user interface. The invention further provides a selector so that a user can select a particular displayed image of interest (the “target image”) from the displayed sequence.

Preferably, the images are displayed simultaneously with said virtual container.

In one embodiment the predetermined rate of the display cycle is adjustable by said processor in dependence upon content of said images.

Preferably, each image is displayed for between 0.1 seconds and 0.8 seconds.

In one preferred embodiment, each image is displayed for substantially 0.4 seconds.

In another preferred embodiment, the predetermined rate of said display cycle is greater than a rate required to allow for recognition and human visual processing of every image while said display cycle is running.

In a further embodiment the images represent menu options and selection of said at least one target image results in execution of a corresponding menu option.

In one preferred embodiment the images contained in the virtual container are displayed as passing in a display path from one to another part of the virtual container.

In one embodiment the display path is a substantially circular path.

In another embodiment the display path is a substantially linear path.

Preferably, the images are displayed such that any image passing from the virtual container is clear of the virtual container before the subsequent image passes from the virtual container.

In one embodiment the images are displayed as moving smoothly over the display path.

In another embodiment the images are moved in discrete steps along the display path.

In one preferred embodiment the images increase in size to a predetermined point in the display path.

Preferably, the image at the predetermined point is substantially complete.

More preferably, the predetermined point is at top-dead-centre.

In another preferred embodiment the images are of substantially uniform size.

Preferably, the images are overlapping images.

In one embodiment all of the images are displayed outside of the virtual container.

In another embodiment a predetermined number of images are displayed outside of the virtual container at any one time and ones of the images are returned to the vitual container before others of the images are displayed.

In another preferred embodiment the images are displayed such as to be superimposed one above the other.

In one embodiment the images are displayed in a continuous cycle.

In another embodiment the images are displayed in a predeterminable number of cycles.

Preferably, the display displays a control panel for enabling control of the display of the images from the virtual container.

More preferably, the control panel includes a forward step button for stepping forwards through the images, a backward step button for stepping backwards through the images, and a stop button for stopping the display of the images.

In a preferred embodiment the control panel further includes an indicator which is progressively filled corresponding to the stage in the display cycle, thereby providing a user with a perception of the number of images in the virtual container and the current position in the display cycle.

In another embodiment the control panel comprises a speed control and the predetermined rate is adjustable via the speed control.

In a further embodiment the display cycle has a forward mode and a reverse mode and the control panel comprises a reverse control for changing the display cycle between the forward mode and the reverse mode.

Viewed from another aspect the invention provides a method for presenting images contained in a virtual container, said method comprising the steps of:

(i) displaying at least one virtual container;

(ii) driving said display to display images contained in the at least one virtual container which is displayed on said display; and

(iii) controlling a processor to drive said display via a user interface;

wherein said images are displayed sequentially in a display cycle at a predetermined rate, said rate being adjustable in operation and wherein said user interface has a selector operable to select at least one target image from said display cycle.

Preferably, the images are displayed simultaneously with said virtual container.

In one embodiment the predetermined rate of the display cycle is adjustable by said processor in dependence upon content of said images.

Preferably, each image is displayed for between 0.1 seconds and 0.8 seconds.

In one preferred embodiment, each image is displayed for substantially 0.4 seconds.

In another preferred embodiment, the predetermined rate of said display cycle is greater than a rate required to allow for recognition and human visual processing of every image while said display cycle is running.

In a further embodiment the images represent menu options and selection of said at least one target image results in execution of a corresponding menu option.

In one preferred embodiment the images contained in the virtual container are displayed as passing in a display path from one to another part of the virtual container.

In one embodiment the display path is a substantially circular path.

In another embodiment the display path is a substantially linear path.

Preferably, the images are displayed such that any image passing from the virtual container is clear of the virtual container before the subsequent image passes from the virtual container.

In one embodiment the images are displayed as moving smoothly over the display path.

In another embodiment the images are moved in discrete steps along the display path.

In one preferred embodiment the images increase in size to a predetermined point in the display path.

Preferably, the image at the predetermined point is substantially complete.

More preferably, the predetermined point is at top-dead-centre.

In another preferred embodiment the images are of substantially uniform size.

Preferably, the images are overlapping images.

In one embodiment all of the images are displayed outside of the virtual container.

In another embodiment a predeterminable number of images are displayed outside of the virtual container at any one time and ones of the images are returned to the virtual container before others of the images are displayed.

In another preferred embodiment the images are displayed such as to be superimposed one above the other.

In one embodiment the images are displayed in a continuous cycle.

In another embodiment the images are displayed in a predeterminable number of cycles.

Preferably, a control panel is displayed on the display for enabling control of the display of the images from the virtual container.

More preferably, the control panel includes a forward step button for stepping forwards through the images, a backward step button for stepping backwards through the images, and a stop button for stopping the display of the images.

In a preferred embodiment the control panel further includes an indicator which is progressively filled corresponding to the stage in the display cycle, thereby providing a user with a perception of the number of images in the virtual container and the current position in the display cycle.

In another embodiment the control panel comprises a speed control and the predetermined rate is adjustable via the speed control.

In a further embodiment the display cycle has a forward mode and a reverse mode and the control panel comprises a reverse control for changing the display cycle between the forward mode and the reverse mode.

### BRIEF DESCRIPTION OF THE DRAWINGS

The above and other objects, features and advantages of the invention will be apparent from the following retailed description of illustrative embodiments which is to be read in connection with the accompanying drawings, in which:

FIG. 1 schematically illustrates an image presentation system in accordance with a preferred embodiment of the present invention;

FIGS. 2(a) to (h) illustrate a sequence of the images presented in one mode of operation of the system;

FIGS. 3(a) to (h) illustrate a sequence of the images presented in another mode of operation of the system;

FIGS. 4(a) to (h) illustrate a sequence of the images presented in another mode of operation of the system;

FIG. 5 illustrates a control panel icon in accordance with a preferred embodiment of the present invention;

FIG. 6 illustrates one implementation of the control panel icon of FIG. 5; and

FIG. 7 illustrates another implementation of the control panel icon of FIG. 5;

FIG. 8 is a flow chart that illustrates how a display sequence of images is controlled according to an embodiment of the present invention;

FIG. 9 illustrates a control panel icon corresponding to the flow chart of FIG. 8.

FIGS. 10(a) to (h) illustrate a sequence of the images presented in a mode of operation of the system where only a subset of the images can be displayed at any one time;

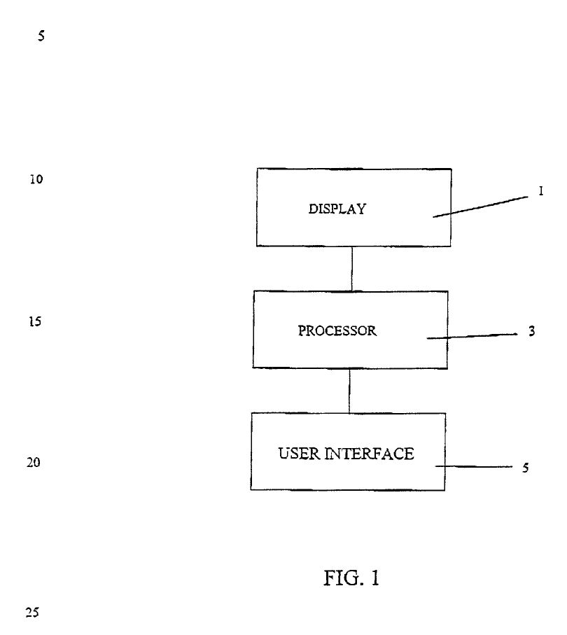

### DESCRIPTION OF THE PREFERRED EMBODIMENTS

The system comprises a display 1, a processor 3 for driving the display 1 to display images I contained in a virtual container C (“miscellaneous”) displayed on the display I, and a user interface 5 for controlling the processor 3 to drive the display 1. In this embodiment the virtual container C is a virtual folder and the images I are pictorial images I contained therein, but in other embodiments the images I could be images I representative of the content of any virtual container C. In preferred embodiments the system is a computer system or mobile telephone, and the user interface 5 is a mouse or touch screen.

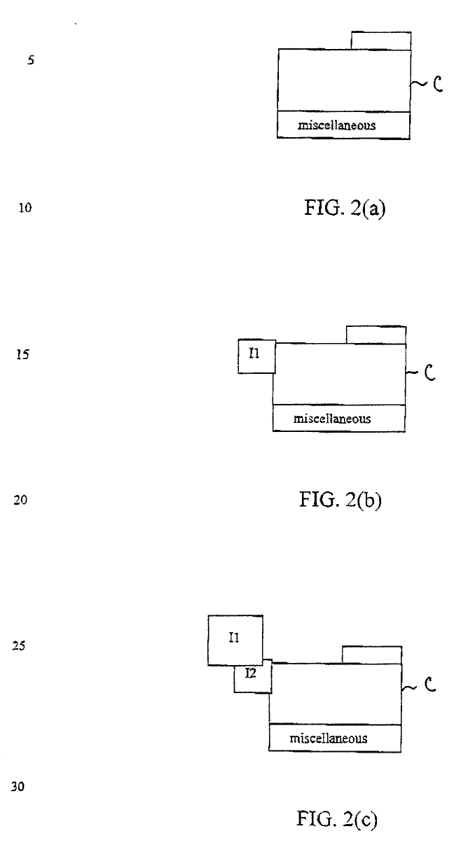

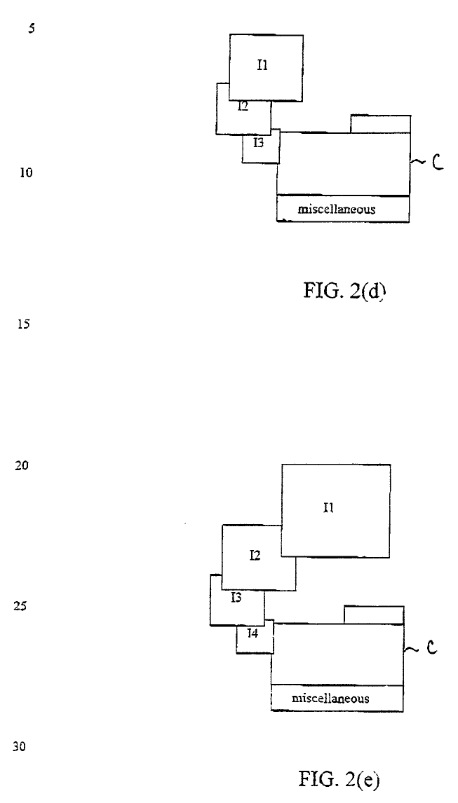

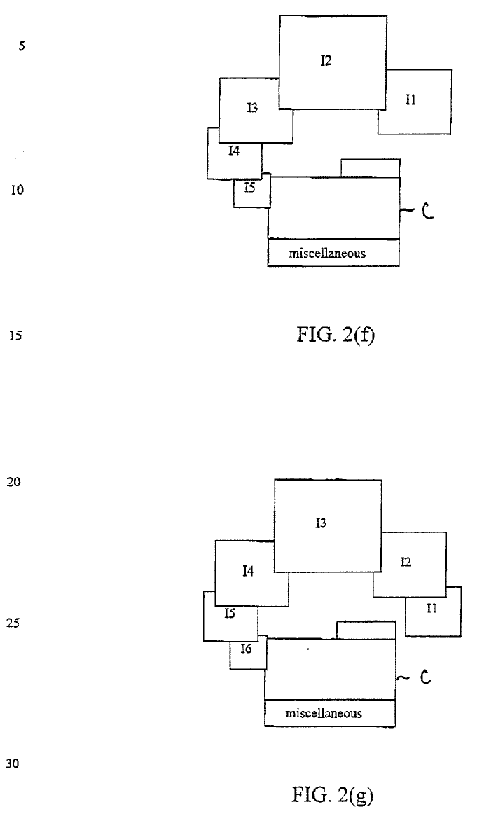

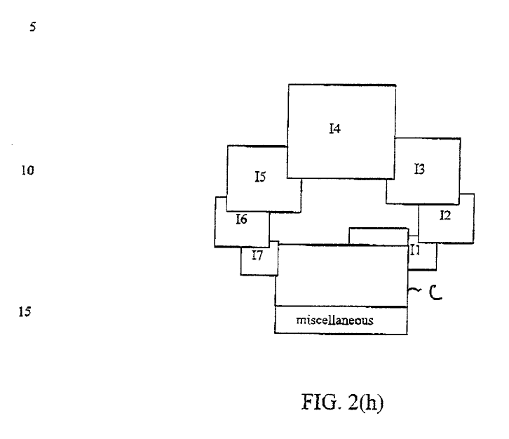

The system has numerous modes of operation and certain of those modes of operation will be described in detail hereinbelow. In each mode, in a quiescent or inactive state, as illustrated in FIGS. 2(a), 3(a) and 4(a), a virtual container C (“miscellaneous”) containing a plurality of pictorial images I is displayed on the display 1.

In a first mode of operation, in response to user input through the user interface 5, as illustrated in FIGS. 2(b) to (h), the images I contained in the virtual container C are displayed as passing from one side, in this embodiment the left-hand side, of the virtual container C to the other side, in this embodiment the right-hand side, of the virtual container C. The images I follow a display path, in this embodiment a circular path, which extends between the one and the other sides of the virtual container C, and are displayed such that any image I passing from the virtual container C is clear of the virtual container C before the subsequent image I passes from the virtual container C.

In this embodiment the images I are overlapping images and increase in size to a predetermined point in the display path, here at top-dead-centre, with the image I at that point being complete. In other embodiments the size of the images I can remain substantially constant.

In this embodiment as the number of images I in the virtual container C is small, all of the images I are displayed outside of the virtual container C, but in other embodiments, where the number of images I in the virtual container C is large and cannot all be displayed simultaneously outside of the virtual container C, a predetermined number of images I are displayed outside of the virtual container C at any one time and certain of the images I are returned to the virtual container C before others of the images I are displayed.

In this embodiment the images I are displayed continuously as an endless loop until user input is received to stop the display of the images I from the virtual container C. In other embodiments the images I can be displayed once or a predetermined number of times in the display path.

In this embodiment the images I are displayed as moving smoothly over the display path, but in other embodiments the images I could be moved in discrete steps along the display path.

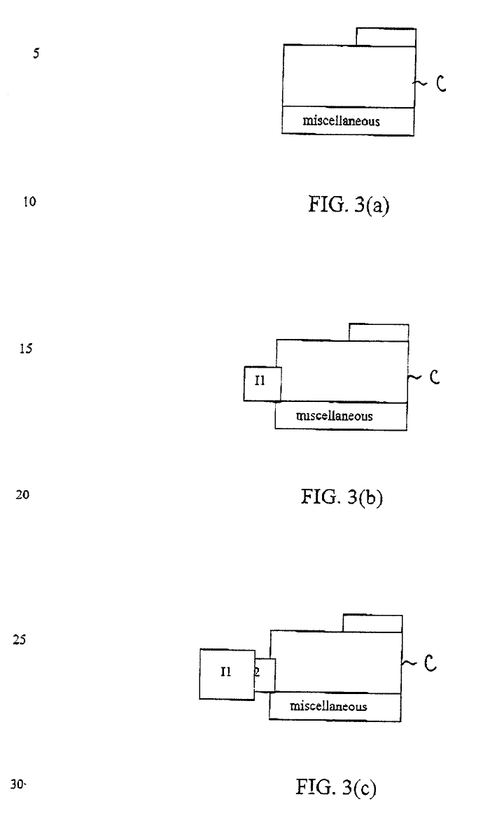

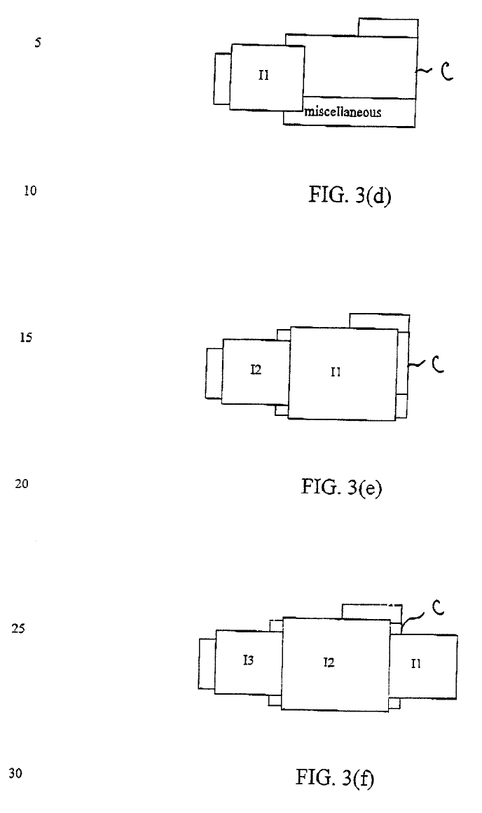

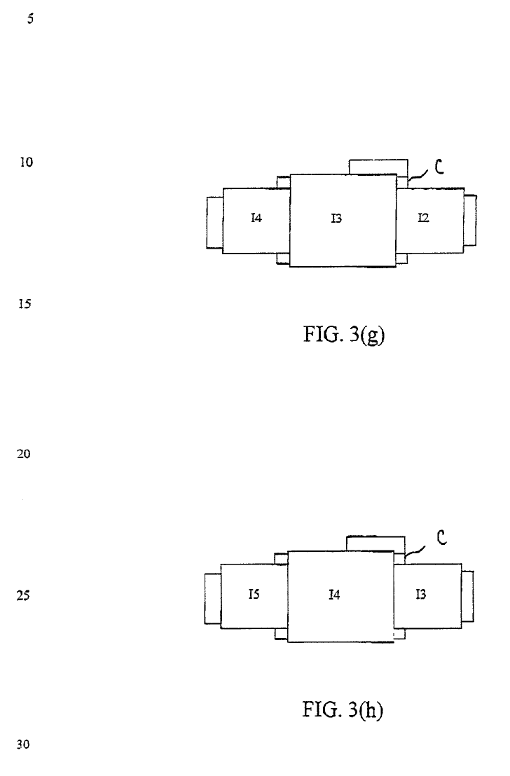

In another mode of operation, as illustrated in FIGS. 3(a) to (h), the display path can be such as to extend directly over the virtual container C, thereby effectively displaying the images I along a single line.

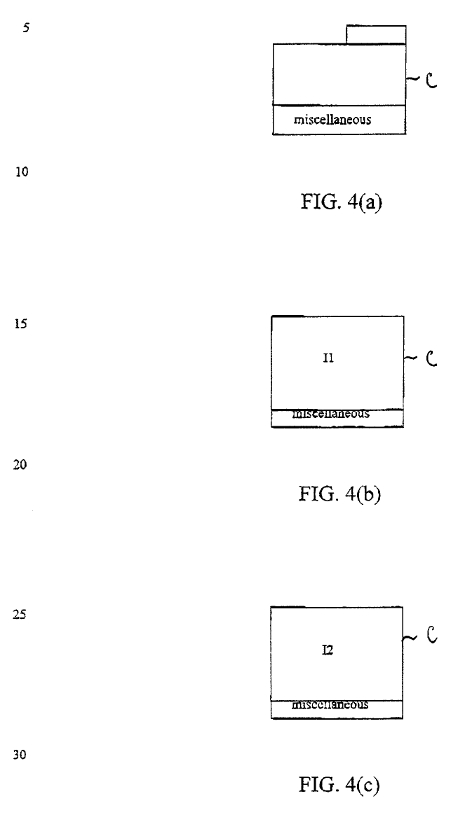

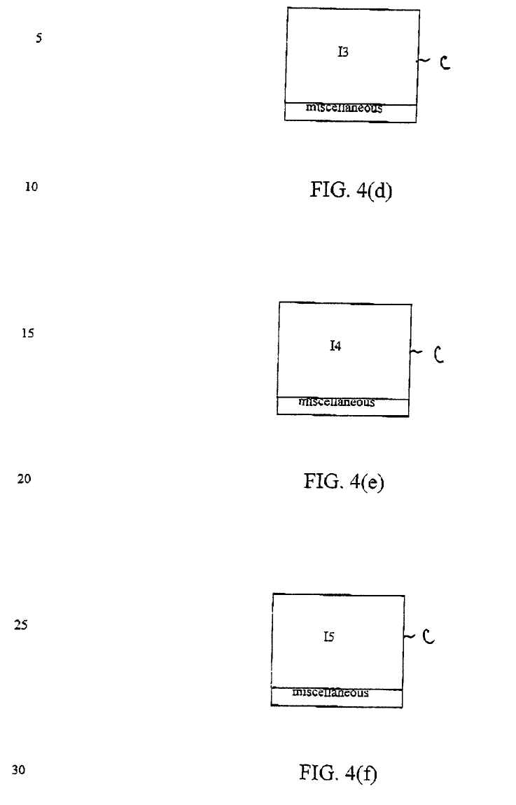

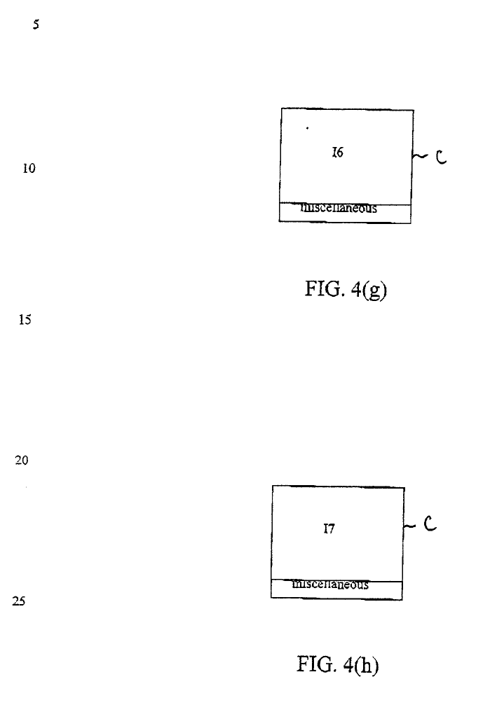

In a further mode of operation, as illustrated in FIGS. 4(a) to (h), the images I are displayed such as to be superimposed one above the other, thereby creating an effect similar to that as would be achieved as by flicking through the pages of a book.

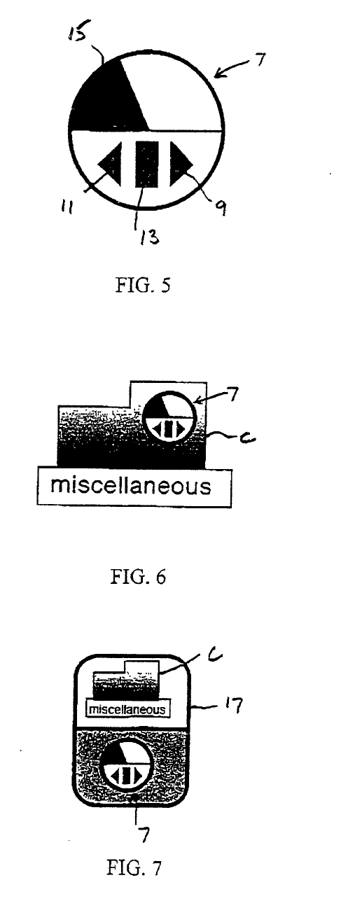

FIG. 5 illustrates a control panel icon 7 in accordance with a preferred embodiment of the present invention for enabling control of the display of the images I from the virtual container C.

The icon 7 includes a forward step button 9 for stepping forwards through the images I, a backward step button 11 for stepping backwards through the images I, and a stop button 13 for stopping the display of the images I.

The icon 7 also includes an indicator 15, in this embodiment a semi-circular segment, which is progressively filled corresponding to the stage in the carousel cycle, thereby providing a user with a perception of the number of images I in the virtual container C and the current position in the carousel cycle.

In this embodiment the images I in the virtual container C are displayed by clicking on the icon 7, and a user can stop the display cycle by clicking on the stop button 13 to scrutinise a particular image I. Also, the user is able to toggle through the images I, either forwards or backwards, by clicking on the forward or backward step buttons 9, 11.

FIGS. 6 and 7 illustrate two implementations of the icon 7. In one implementation, as illustrated in FIG. 6, the icon 7 is displayed on the virtual container C. In another implementation, as illustrated in FIG. 7, the icon 7 is provided in a magic lens 17 which can be moved using the user interface 5 so as to be positioned over a virtual container C of interest.

The RSVP characteristic of the brain's visual processing can be exploited by displaying images in rapid temporal succession, thus allowing for efficient cycling through a large number of options. The image cycle rate must be slow enough to allow for recognition and visual processing of a target image to enable it to be selected, but need not be so slow as to allow for every image in the sequence to be recognised and visually processed during the image cycle. Once the target image has been identified, the user can stop the display cycle via the user interface.

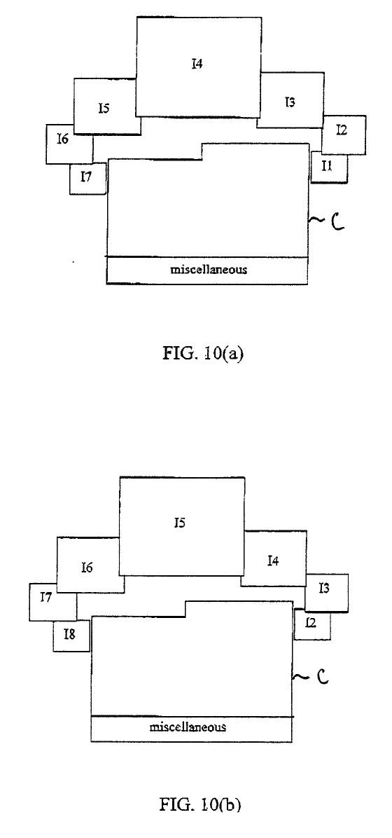

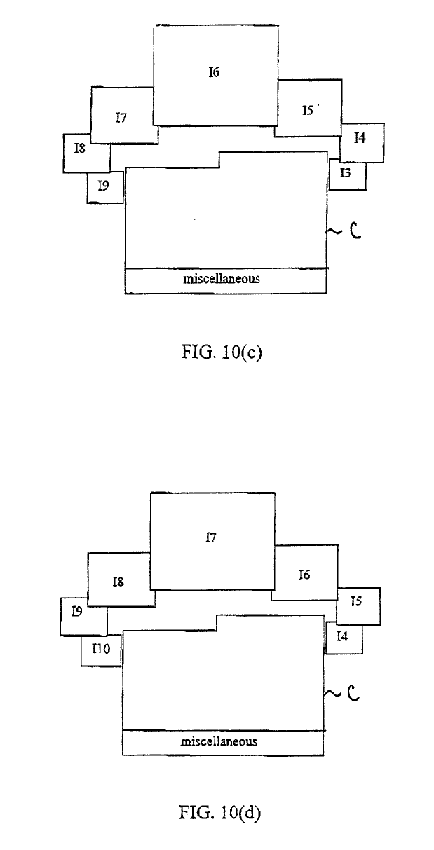

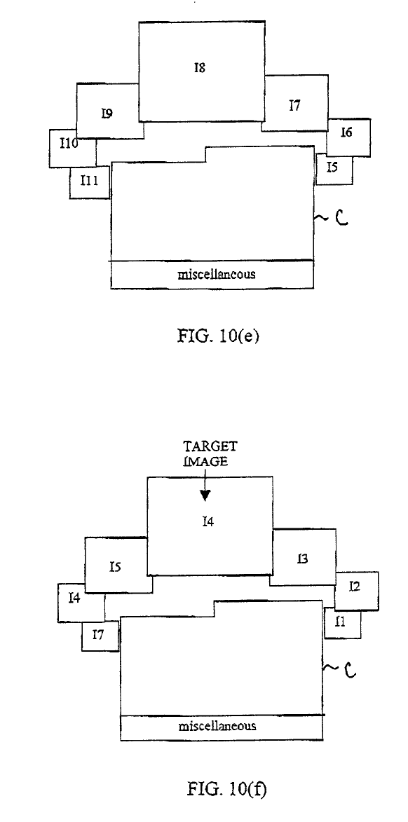

There will inevitably be a delay due to user reaction time between recognition of a target image and initiation of the user command to stop the display cycle or to select the displayed image. To allow for finite user reaction time a back control is provided to allow tracking back through the image sequence. This back control facilitates relocation of the target image once it has been recognised, even if it has disappeared from the display before the user reacted to select it or to stop the cycle. This is explained further below with reference to FIG. 10.

The cycle rate of the images can be adjusted in dependence upon the image type. For example, visual processing of a simple and distinctive line-drawn image will typically take less time than visual processing of an information-dense photographic image. The cycle rate may be determined automatically via an algorithm run by the processor, for example, by using “activity” as a measure of the information content of the image. Activity is a measure calculated from the appropriately normalised pixel variance of an image block. Alternatively the user could be prompted to provide objective input on the image type to be displayed and the cycle rate could be set accordingly by the algorithm. The cycle rate is also adjustable between one or more rates via the user interface.

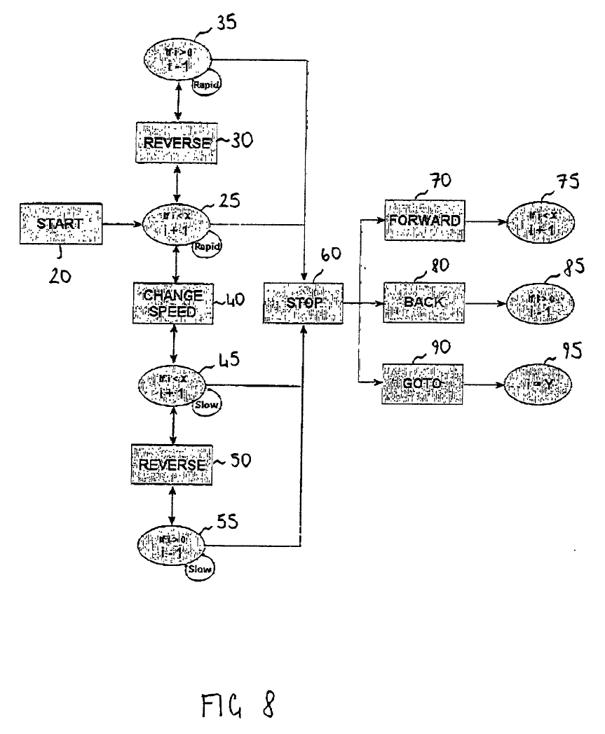

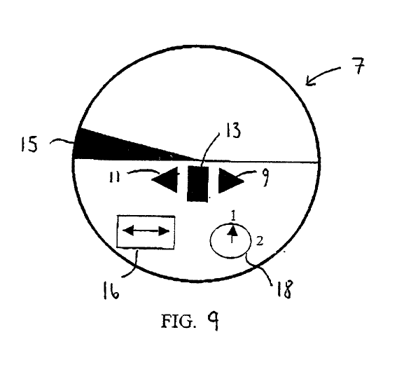

FIG. 8 is a flow chart that illustrates how the display sequence of images is controlled according to an embodiment. In the flow chart, the rectangles represent events whereas the ovals represent processes. The integer x represents the total number of images in the virtual container while the integer i (0≦i≦x) is an image index:- i=0 corresponds to the beginning of the display sequence which is a state where the virtual container is displayed but none of the x images is displayed; i=1 corresponds to the point in the sequence where image I1 most recently emerged from the virtual container, i=2 corresponds to when image I2 was the image that most recently emerged from the virtual container and so on until i=x.

At event 20, in response to user input via the user interface 5, the image display cycle is started. At process 25 the processor determines the current value of the index i. If i<x then i is successively incremented by one and each time i is incremented the corresponding image Ii emerges from the virtual container and is displayed. The process may continue uninterrupted until i=x. Process 25 corresponds to a first predetermined cycle rate which is a rapid cycle rate. After the image corresponding to i=x has been displayed, i is set equal to zero and the image display sequence is terminated. The display sequence can be reinitiated by starting the cycle using the start event 20.

When the user activates a reverse event 30, the direction of the image cycle reverses and process 35 is initiated. During process 35 it is determined whether i>0 and if this condition is met i is decremented so that that the display sequence runs in a reverse order. This reverse order display cycle can continue until i=0 when only the virtual container is displayed. The reverse sequence display cycle of process 35 occurs at the same predetermined rapid cycle rate as the forward display cycle of process 25.

During the forward display cycle process 25, the cycle rate is changed when the user interrupts the cycle by initiating a change speed event 40 via the user interface 5. This has effect of reducing the display cycle rate from the rapid cycle rate of process 25 to a second predetermined cycle rate which is a slow cycle rate and corresponds to process 45. Process 45 is a forward display cycle process. In this case triggering the change speed event 40 allows the user to reduce the cycle rate thus allowing more time for target image recognition. During execution of process 45, a reverse event 50 can be triggered whereupon the display cycle process reverses direction but continues to run at the predetermined slow cycle rate. Reversal of the cycle allows the user to track back in the sequence in order to locate a recognised target image.

During execution any one of the rapid forward cycle process 25, the rapid reverse cycle process 35, the slow forward cycle process 45, or the slow reverse cycle process 55 described, above the user can trigger a stop event 60 to freeze the displayed image sequence at that point in time. Typically the user will trigger the stop event 60 upon recognition of a target image. Once the image display sequence has been stopped, the user can navigate through the display sequence frame-by-frame. Using a forward event 70 control, the user can navigate forwards in the image display cycle as represented by process 75. Similarly by using backward event 80 control, the user can navigate backwards in the display cycle as represented by process 85. Furthermore, triggering a goto event 90 will result in the user being prompted to and enter an image index. If the index i=Y is entered then the apparatus will navigate directly to the point in the image display sequence where image IY has just emerged from the virtual container C.

Although in this embodiment only two cycle speeds are used, one rapid and one slow, in alternative embodiments a wider range of cycle speeds may be provided. Taking account of RSVP characteristic of the brain's visual processing the predetermined rate of said display cycle may be set such that it is greater than a rate required to allow for recognition and human visual processing of every image while the display cycle is running. The user will typically be able to recognise a target image in a rapid display sequence and to select that image by back-tracking in the sequence to relocate the recognised target image in the event that the target image has returned to the virtual container before the user has been able to select it. The cycle speed could be such that each image is displayed for between 0.1 seconds and 0.8 seconds. However in typical applications each image will be displayed for substantially 0.4 seconds.

FIG. 9 illustrates a control panel icon 7 for enabling the control of the display images I from the virtual container C for use with the embodiment corresponding to the flow chart of FIG. 8. In addition to the forward step button 9, the backward step button 11 and the stop button 13 which were also provided in the embodiment of FIG. 5, a reverse button 16 is provided for reversing the direction of the display cycle and a speed dial 18 is provided for adjusting the cycle rate of the images I. The speed dial 18 has two predetermined speed settings: setting 1 corresponds to the slow cycle rate whereas setting 2 corresponds to the fast cycle rate. The reverse button 16 is used to trigger the reverse events 30 and 50 of FIG. 8 whilst the speed dial is used to trigger the change speed event 40.

FIG. 10 illustrates an embodiment of the invention in which the images I contained in the virtual container C emerge from the left hand side of the container, follow a display path above the container and are returned to the virtual container at the right hand side. The embodiment of FIG. 10 is similar to the embodiment of FIG. 2 except that in FIG. 10 the number of images in the virtual container C is too large for them all to be displayed simultaneously outside the container. In this embodiment a maximum of 7 images can be displayed simultaneously. FIG. 10(a) shows the display cycle corresponding to i=7 (since 17 has just emerged from the left hand side of the container) and the first 7 images are on display. FIGS. 10(b), 10(c) and 10(d) correspond to I=8, 9 and 10 respectively and represent successive frames of the display cycle running in a forward direction or forward mode. FIG. 10(e) corresponds to I=11 and in this stage of the cycle images I1, I2, I3 and I4 have returned to the virtual container and are no longer displayed. Suppose that the user intends to select a menu icon corresponding to image I4 so that I4 is the target image. The user first notices I4 when it is at the top-centre of the display path as in FIG. 10(a). However, since the image cycle proceeds at a rapid rate, there being a large number of images in the virtual container to cycle through, the user triggers the stop button only in time to stop the sequence at the cycle stage of FIG. 10(e) when I4 has just disappeared from the display cycle.

In order to relocate the image I4 the user uses the backward step button to step back through the cycle. By pressing the backward step button four times in succession the display cycle returns through stages 10(d), 10(c), 10(b) to stage 10(a). Thus the user arrives at the cycle stage of FIG. 10(f) with the target image I4 at the top-centre of the display as shown. Alternatively, the user could press the reverse button 16, whereupon the cycle would switch from the forward mode to a reverse mode and cycle automatically backwards, passing sequentially through stages 10(d), 10(c), 10(b) to stage 10(a) at the predetermined cycle rate. The user then double clicks on the image I4 to select that image. In this case this image is a menu icon and selecting it results in the particular menu option corresponding to the image icon I4 being launched. In this embodiment the image selection position corresponds to the top-centre position where the displayed image is largest. However in alternative embodiments any of the displayed images could be selected.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. An apparatus for presenting images contained in a virtual container, comprising:
(i) a display for displaying at least one virtual container,
(ii) a processor for driving the display to display images contained in said at least one virtual container which is displayed on said display; and
(iii) a user interface for controlling said processor to drive said display;
wherein said images are displayed sequentially in a display cycle at a predetermined rate, said rate being adjustable in operation and wherein said user interface has a selector operable to select at least one target image from said display cycle.

2. The apparatus of claim 1, wherein said images are displayed simultaneously with said virtual container.

3. The apparatus of claim 1, wherein said rate is adjustable by said processor in dependence upon content of said images.

4. The apparatus of claim 1, wherein each image is displayed for between 0.1 seconds and 0.8 seconds.

5. The apparatus of claim 1, wherein each image is displayed for substantially 0.4 seconds.

6. The apparatus of claim 1, wherein said predetermined rate of said display cycle is greater than a rate required to allow for recognition and human visual processing of every image while said display cycle is running.

7. The apparatus of claim 1, wherein said images represent menu options and selection of said at least one target image results in execution of a corresponding menu option.

8. The apparatus of claim 1, wherein said images contained in said virtual container are displayed as passing in a display path from one to another part of said virtual container.

9. The apparatus of claim 8, wherein said display path is a substantially circular path.

10. The apparatus of claim 8, wherein said display path is a substantially linear path.

11. The apparatus of claim 8, wherein said images are displayed such that any image passing from the virtual container is clear of the virtual container before the subsequent image passes from the virtual container.

12. The apparatus of claim 8, wherein said images are displayed as moving smoothly over the display path.

13. The apparatus of claim 8, wherein said images are moved in discrete steps along the display path.

14. The apparatus of claim 8, wherein said images increase in size to a predetermined point in the display path.

15. The apparatus of claim 14, wherein said image at said predetermined point is substantially complete.

16. The apparatus of claim 14, wherein said predetermined point is at top-dead-centre.

17. The apparatus of claim 1, wherein said images are of substantially uniform size.

18. The apparatus of claim 8, wherein said images are overlapping images.

19. The apparatus of claim 1, wherein all of said images are displayed outside of the virtual container.

20. The apparatus claim 1, wherein a predetermined number of images are displayed outside of said virtual container at any one time and ones of said images are returned to the virtual container before others of said images are displayed.

21. The apparatus of claim 1, wherein said images are displayed such as to be superimposed one above the other.

22. The apparatus of claims 1, wherein said images are displayed in a continuous cycle.

23. The apparatus of claim 1, wherein said images are displayed in a predetermined number of cycles.

24. The apparatus of claims 1, wherein said display displays a control panel for enabling control of the display of the images from said virtual container.

25. The apparatus of claim 24, wherein said control panel includes a forward step button for stepping forwards through said images, a backward step button for stepping backwards through said images, and a stop button for stopping the display of said images.

26. The apparatus of claim 24, wherein said control panel further includes an indicator which is progressively filled corresponding to the stage in the display cycle, thereby providing a user with a perception of the number of images in the virtual container and the current position in the display cycle.

27. The apparatus of claim 24, wherein said control panel comprises a speed control and said predetermined rate is adjustable via said speed control.

28. The apparatus of claim 24, wherein said display cycle has a forward mode and a reverse mode and said control panel comprises a reverse control for changing said display cycle between said forward mode and said reverse mode.

29. A method for presenting images contained in a virtual container, said method comprising the steps of:
(i) displaying at least one virtual container;
(ii) driving said display to display images contained in the at least one virtual container which is displayed on said display; and
(iii) controlling a processor to drive said display via a user interface;
wherein said images are displayed sequentially in a display cycle at a predetermined rate, said rate being adjustable in operation and wherein said user interface has a selector operable to select at least one target image from said display cycle.

30. The method of claim 29, wherein said images are displayed simultaneously with said virtual container.

31. The method of claim 29, wherein said predetermined rate is adjustable in dependence upon content of said images.

32. The method of claim 29, wherein each image is displayed for between 0.1 seconds and 0.8 seconds.

33. The method of claim 29, wherein each image is displayed for substantially 0.4 seconds.

34. The method of claim 29, wherein said predetermined rate of said display cycle is greater than a rate required to allow for recognition and human visual processing of every image while said display cycle is running.

35. The method of claim 29, wherein said images represent menu options and selection of said at least one target image results in execution of a corresponding menu option.

36. The method of claim 29, wherein the images contained in said virtual container are displayed as passing in a display path from one to another part of said virtual container.

37. The method of claim 29, wherein said display path is a substantially circular path.

38. The method of claim 29, wherein the display path is a substantially linear path.

39. The method of claim 29, wherein said images are displayed such that any image passing from said virtual container is clear of said virtual container before a subsequent image passes from said virtual container.

40. The method of claim 36, wherein said images are displayed as moving smoothly over said display path.

41. The method of claim 36, wherein said images are moved in discrete steps along said display path.

42. The method of claim 36, wherein said images increase in size to a predetermined point in said display path.

43. The method of claim 42, wherein said image at said predetermined point is substantially complete.

44. The method of claim 42, wherein the predetermined point is at top-dead-centre.

45. The method of claim 29, wherein the images are of substantially uniform size.

46. The method of claims 29, wherein the images are overlapping images.

47. The method of claims 29, wherein all of the images are displayed outside of the virtual container.

48. The method of claims 29, wherein a predetermined number of images are displayed outside of the virtual container at any one time and ones of said images are returned to the virtual container before others of said images are displayed.

49. The method of claim 29, wherein the images are displayed such as to be superimposed one above the other.

50. The method of claim 29, wherein said images are displayed in a continuous cycle.

51. The method of claim 29, wherein said images are displayed in a predetermined number of cycles.

52. The method of claim 29, wherein a control panel is displayed on said display for enabling control of display of said images from said virtual container.

53. The method of claim 52, wherein said control panel includes a forward step button for stepping forwards through said images, a backward step button for stepping backwards through said images, and a stop button for stopping display of said images.

54. The method of claim 52, wherein said control panel further includes an indicator which is progressively filled corresponding to a stage in said display cycle, thereby providing a user with a perception of the number of images in said virtual container and the current position in said display cycle.

55. The method of claim 52, wherein said control panel comprises a speed control and said predetermined rate is adjustable via said speed control.

56. The method of claim 52, wherein said display cycle has a forward mode and a reverse mode and said control panel comprises a reverse control for changing said display cycle between said forward mode and said reverse mode.
